(19) United States
(12) Patent Application Publication
(10) Pub. No.: US 2024/0253710 A1
(43) Pub. Date: Aug. 1, 2024

(54) Bedslide No Drill Mounting Bracket

(71) Applicant: Leer Group, Elkhart, IN (US)

(72) Inventors: Eugene A. Dylewski, II, Granger, IN (US); Adrian Cook, Raymond, WA (US); Aaron J. Peterson, Clearwater, FL (US); Vadim Luban, South Bend, IN (US)

(21) Appl. No.: 18/418,716

(22) Filed: Jan. 22, 2024

Related U.S. Application Data
(60) Provisional application No. 63/441,355, filed on Jan. 26, 2023.

(51) Int. Cl. B62D 33/02

(52) U.S. Cl. CPC B62D 33/0207

(57) ABSTRACT

A bedslide mounting bracket assembly is provided. The bedslide mounting bracket assembly is configured to secure a bedslide assembly to a pickup truck cargo box. The bedslide mounting bracket assembly includes a wing bulkhead bracket and a bulkhead mounting bracket. The wing bulkhead bracket is configured to be attached to the bedslide assembly. The bulkhead mounting bracket includes at least one fastener and at least one pin. The wing bulkhead bracket receives the at least one fastener and the at least one pin of the bulkhead mounting bracket. A corresponding nut is engageable to the at least one fastener to secure the wing bulkhead bracket to the bulkhead mounting bracket.

### RELATED APPLICATIONS

The present Application relates to and claims priority to U.S. Provisional Patent Application Ser. No. 63/441,355, filed on Jan. 26, 2023, entitled “Bedslide No Drill Mounting Bracket.” The subject matter disclosed in that Provisional Application is hereby expressly incorporated into the present Application.

### TECHNICAL FIELD AND SUMMARY

The present disclosure relates to trucks, such as pickup trucks and like vehicles, with truck beds or cargo boxes installed thereon. In particular, the present disclosure relates to a bracket assembly that attaches a bedslide assembly to openings or attachment points on the truck bed or cargo box.

A truck bed or cargo box is a large open space of a pickup truck located behind the truck's cab section. The cargo box is typically composed of a floor bounded by opposing sidewalls. A bulkhead extends between the opposed sidewalls and is located adjacent the cab section. A tailgate is located opposite the bulkhead at the rear end of the cargo box and is movable between open and closed positions.

A bedslide assembly is a device that is attached to the cargo box and is extendable and retractable relative to the cargo box floor. For example, the bedslide may be slid over the cargo box floor and contained within the truck bed. Conversely, the bedslide may be pulled from the cargo box over the floor, not unlike a drawer pulled from a cabinet.

Because cargo boxes often include preformed openings and attachment points, it may be beneficial for a bedslide to be attached to these preformed openings and attachment points rather than drilling or otherwise creating new ones. Accordingly, an illustrative embodiment of the present disclosure provides mounting brackets for the frame of a bedslide assembly that can be attached to preformed openings or pockets in the bulkhead of a pickup truck cargo box.

An illustrative embodiment of the present disclosure provides a bedslide mounting bracket assembly configured to secure a bedslide assembly to a pickup truck cargo box. The bedslide mounting bracket assembly includes a wing bulkhead bracket, a bulkhead mounting bracket, and at least one gasket. The wing bulkhead bracket is configured to be attached to the bedslide assembly and be located interior of the pickup truck cargo box adjacent a bulkhead. The bulkhead mounting bracket is configured to be positioned exterior of the pickup truck cargo box adjacent the bulkhead. The bulkhead mounting bracket also includes at least one fastener and at least one pin such that the at least one fastener and the at least one pin are oriented substantially parallel to and spaced apart from each other. The at least one fastener is configured to extend through an opening in the bulkhead from the exterior to the interior of the pickup truck cargo box. The at least one pin is configured to engage at least a portion of a periphery of the opening in the bulkhead. The bulkhead mounting bracket also includes a drain hole disposed therethrough, which is configured to receive a drain tube. The bulkhead mounting bracket further includes a flange, at least a portion of which is configured to be positioned under a floor on the exterior of the pickup truck cargo box. The at least one gasket is configured to be positioned between the wing bulkhead bracket and the bulkhead. The wing bulkhead bracket receives the at least one fastener and the at least one pin of the bulkhead mounting bracket. A corresponding nut is engageable by the at least one fastener to secure the wing bulkhead bracket to the bulkhead mounting bracket.

In the above and other embodiments, the bedslide mounting bracket assembly may further comprise: the wing bulkhead bracket including a bulkhead panel portion and a bedslide frame portion, wherein the bulkhead panel portion is configured to receive the at least one fastener and the at least one pin of the bulkhead mounting bracket, and the bedslide frame portion is configured to attach to a bedslide frame; a drain hole plug that selectively caps the drain hole; the at least one fastener being at least one bolt; the at least one pin being configured to be supported by the portion of the periphery of the opening in the bulkhead; the bulkhead mounting bracket does not block the drain hole; the at least one fastener is a plurality of fasteners, wherein each of the plurality of fasteners extends from the bulkhead mounting bracket and through the wing bulkhead bracket; the each of the plurality of fasteners receives the corresponding nut to secure the bulkhead mounting bracket to the wing bulkhead bracket; and the flange, at least the portion of which is configured to be positioned under the floor on the exterior of the pickup truck cargo box and is configured to resist an upward force exerted on the wing bulkhead bracket by the bedslide assembly.

Another illustrative embodiment of the present disclosure provides a bedslide mounting bracket assembly configured to secure a bedslide assembly to a pickup truck cargo box. The bedslide mounting bracket assembly includes a wing bulkhead bracket and a bulkhead mounting bracket. The wing bulkhead bracket is configured to be attached to the bedslide assembly. The bulkhead mounting bracket includes at least one fastener and at least one pin. The wing bulkhead bracket receives the at least one fastener and the at least one pin of the bulkhead mounting bracket. A corresponding nut is engageable to the at least one fastener to secure the wing bulkhead bracket to the bulkhead mounting bracket.

In the above and other embodiments, the bedslide mounting bracket assembly may further comprise: the wing bulkhead bracket being configured to be attached to the bedslide assembly and be located interior of the pickup truck cargo box adjacent a bulkhead; the bulkhead mounting bracket being configured to be positioned exterior of the pickup truck cargo box adjacent a bulkhead; the at least one fastener and the at least one pin are oriented substantially parallel to and spaced apart from each other; the at least one fastener is configured to extend through an opening in the bulkhead from the exterior to an interior of the pickup truck cargo box; the at least one pin being configured to engage at least a portion of a periphery of an opening in a bulkhead; a drain hole disposed through the bulkhead mounting bracket and configured to receive a drain tube; the bulkhead mounting bracket further including a flange, wherein at least a portion of which is configured to be positioned under a floor on an exterior of the pickup truck cargo box; and at least one gasket configured to be positioned between the wing bulkhead bracket and a bulkhead.

Another illustrative embodiment of the present disclosure provides a method of mounting a bedslide bracket assembly to a bedslide assembly and a bulkhead of a pickup truck cargo box, the method of mounting a bedslide bracket assembly comprising the steps of: providing a wing bulkhead bracket; attaching the wing bulkhead bracket to a bedslide frame of the bedslide assembly; providing a bulkhead mounting bracket having at least one fastener, at least one pin, and a flange; extending the bulkhead mounting bracket through an opening disposed through the bulkhead to an exterior of the pickup truck cargo box; locating at least a portion of the flange of the bulkhead mounting bracket under a floor of the pickup truck cargo box; extending the at least one fastener and the at least one pin through the opening disposed through the bulkhead to the interior of the pickup truck cargo box; supporting the at least one pin on a periphery of the opening disposed through the bulkhead of the pickup truck cargo box; extending the at least one fastener and the at least one pin through corresponding openings in the wing bulkhead bracket that is in the interior of the pickup truck cargo box; and securing the at least one fastener to the wing bulkhead bracket.

In the above and other embodiments, the method of mounting a bedslide bracket assembly to a bedslide assembly may further comprise the steps of: extending the bulkhead mounting bracket through the opening disposed through the bulkhead from the interior of the pickup truck cargo box to exterior of the pickup truck cargo box.

Additional features of the no drill bedslide mounting bracket assembly will become apparent to those skilled in the art upon consideration of illustrative embodiments of carrying out the no drill bedslide mounting bracket assembly as presently perceived.

### BRIEF DESCRIPTION OF THE DRAWINGS

The concepts described in the present disclosure are illustrated by way of example and not by way of limitation in the accompanying figures. For simplicity, and clarity of illustration, elements illustrated in the figures are not necessarily drawn to scale. For example, the dimensions of some elements may be exaggerated relative to other elements for clarity. Further, where considered appropriate, reference labels may be repeated among the figures to indicate corresponding or analogous elements.

FIG. 1 is a perspective view of a portion of a cargo box with the bedslide assembly attached to the cargo box;

FIG. 2 is a perspective view of a portion of the cargo box with the bedslide frame attached to the bulkhead of the cargo box;

FIG. 3 is an isolated perspective view of the bedslide assembly;

FIG. 4 is an isolated perspective view of the bedslide assembly with the deck removed;

FIG. 5 is a detail perspective view of a portion of the cargo box, including the bulkhead and floor with a wing bulkhead bracket attached to the bulkhead;

FIG. 6 is another detail perspective view of a portion of the cargo box, including the bulkhead and floor with the wing bulkhead bracket removed showing the bulkhead pocket;

FIG. 7 is a detail perspective view of a portion of the cargo box positioning the bulkhead mounting bracket on the bulkhead;

FIG. 8 is another detail perspective view of a portion of the cargo box positioning the bulkhead mounting bracket on the bulkhead;

FIG. 9 is a reverse detail perspective view of the cargo box depicting the bulkhead mounting bracket positioned on the exterior side of the bulkhead;

FIG. 10 is a side sectional detail view of a portion of the cargo box demonstrating how the flange of the bulkhead mounting bracket resists upward force exerted on the wing bulkhead bracket when using the bedslide assembly;

FIG. 11 is an exploded view of the wing bulkhead bracket;

FIG. 12 is a reverse perspective detail view of a portion of the bedslide frame with the wing bulkhead brackets extending from each side; and

FIG. 13 is a detail perspective view of a portion of the inside of the cargo box depicting the wing bulkhead bracket attached to the bedslide frame and to the bulkhead panel.

Corresponding reference characters indicate corresponding parts throughout the several views. The exemplification set out herein illustrates embodiments of the no drill bedslide mounting bracket assembly, and such exemplification is not to be construed as limiting the scope of the no drill bedslide mounting bracket assembly in any manner.

### DISCLOSURE OF ILLUSTRATIVE EMBODIMENTS

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

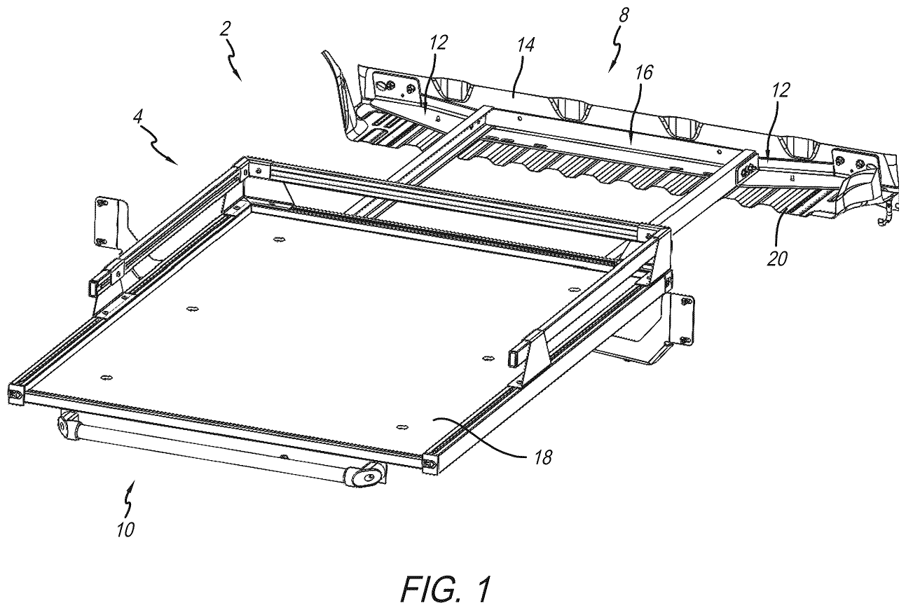

A perspective view of a portion of a cargo box 2, with a bedslide assembly 4 attached to cargo box 2, is shown in FIG. 1. Here, a bedslide frame 6 is attached to cargo box 2 between bulkhead end 8 and tailgate end 10. With respect to bulkhead end 8, wing bulkhead brackets 12 extend from each side of bedslide frame 6 and are attached to bulkhead 14. This holds bedslide frame 6 and, thus, bedslide assembly 4 to cargo box.

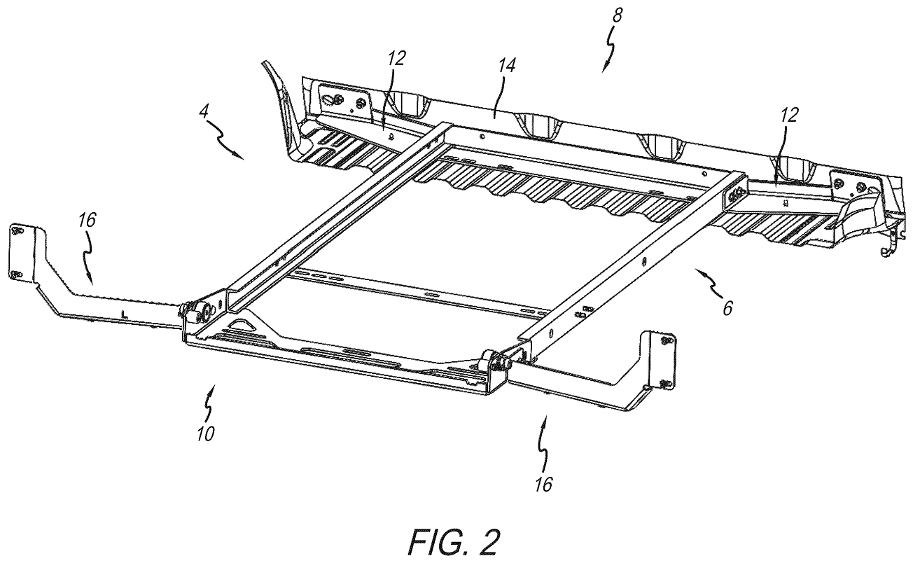

Another perspective view of a portion of cargo box 2, with a bedslide frame 6 attached to bulkhead 14 of cargo box 2, is shown in FIG. 2. This view further demonstrates how wing bulkhead brackets 12 are attached both to bedslide frame 6 and to bulkhead 14. Illustratively, brackets 16 can extend from bedslide frame 6 at a location on frame 6 toward tailgate end 10 of cargo box 2. Brackets 16 may be attached to either pre-existing or newly formed attachment points on the sidewalls (not shown) or on floor 20.

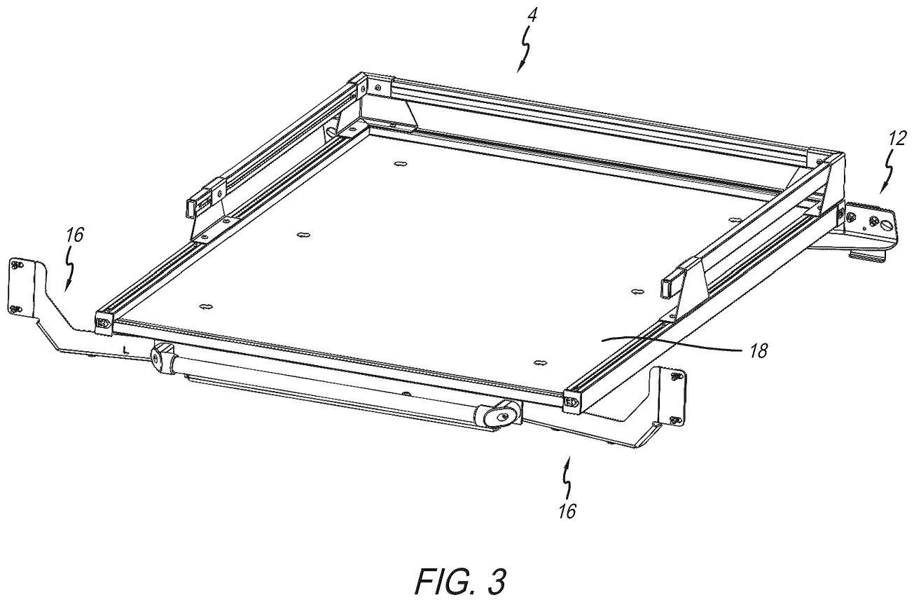

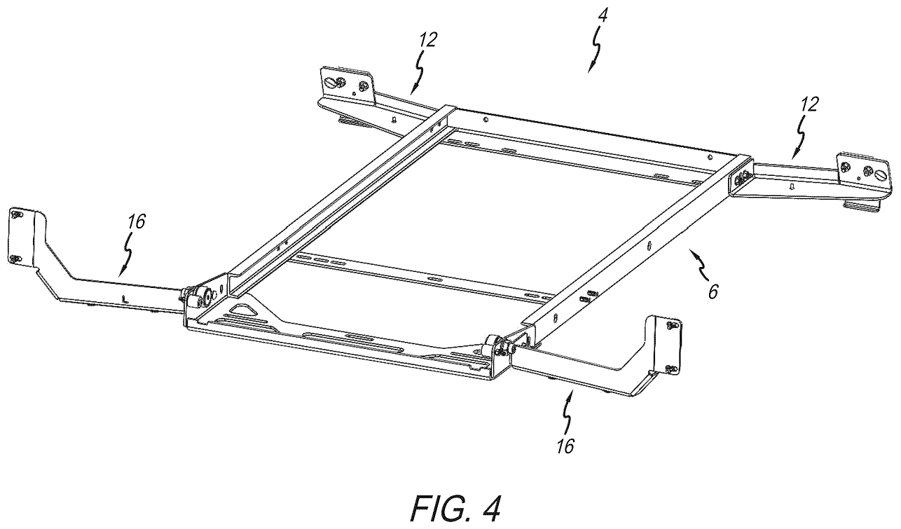

An isolated perspective view of bedslide assembly 4 is shown in FIG. 3. Here, wing bulkhead bracket 12 is shown extending from bedslide assembly 4 with bedslide deck 18. The similar perspective view in FIG. 4 depicts bedslide assembly 4 with bedslide deck 18 removed. In this view, wing bulkhead bracket 12 is attached to and extends from each side of bedslide frame 6. It is appreciated, however, that the attachment point of wing bulkhead bracket 12 to bedslide frame 6 can be on the rear, as well as the side, of same so long as wing bulkhead bracket 12 is in proximity to cargo box bulkhead 14.

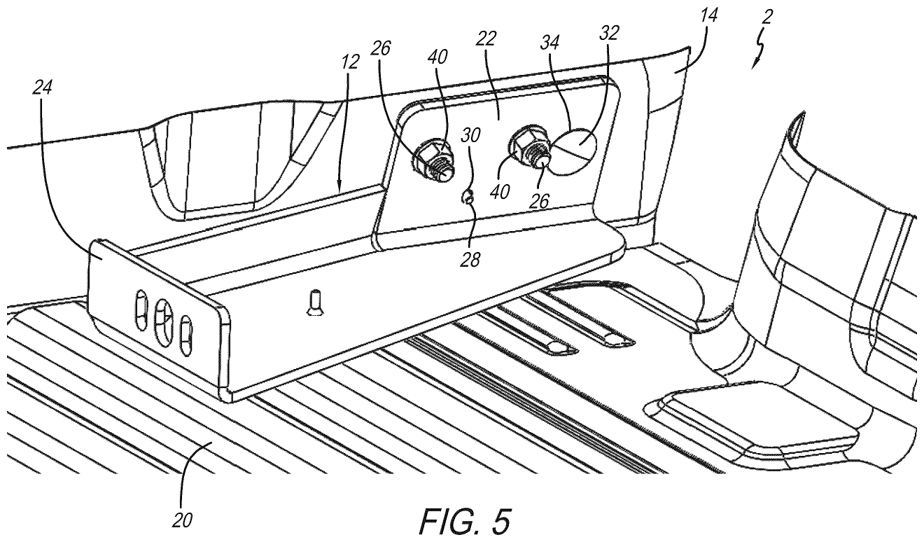

A detail perspective view of a portion of cargo box 2, including bulkhead 14 and floor 20, with a wing bulkhead bracket 12 attached to bulkhead 14, is shown in FIG. 5. This view depicts wing bulkhead bracket 12 isolated from bedslide frame 6. A bulkhead panel portion 22 and bedslide frame portion 24 make up components of wing bulkhead bracket 12. In this view, bulkhead panel portion 22 is shown attached to bulkhead 14 via a plurality of bolts 26. A pin 28 is shown extended through a pin opening 30 in bulkhead panel portion 22 as well. Also shown is a drain hole plug 32 that selectively caps a drain hole 34 disposed through bulkhead panel portion 22.

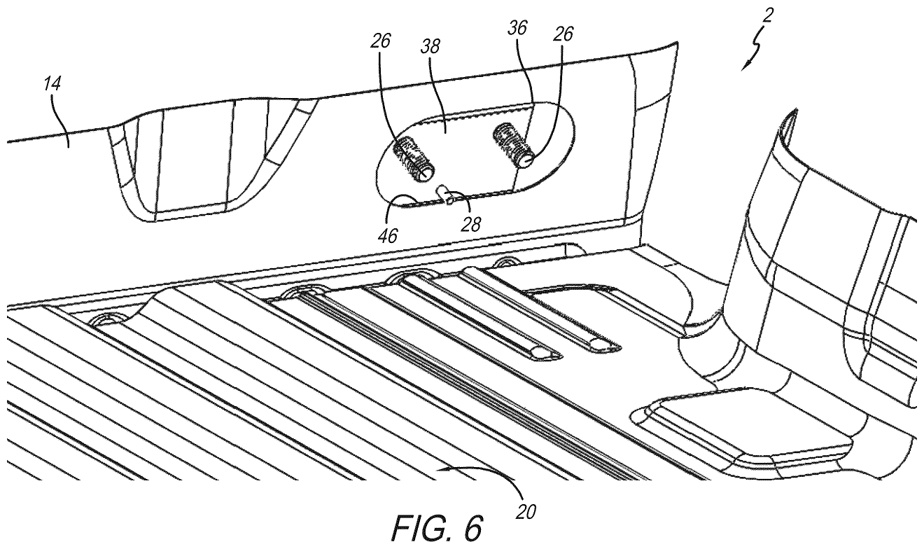

Another detail perspective view of a portion of cargo box 2, including bulkhead 14 and floor 20, is shown in FIG. 6. This view, in contrast to that of FIG. 5, has wing bulkhead bracket 12 removed to show bulkhead pocket 36 therebehind. This bulkhead pocket 36 is disposed in bulkhead 14 and represents a standard preformed opening that may exist in some cargo box bulkheads. Behind bulkhead 14, as shown through bulkhead pocket 36, is a bulkhead mounting bracket 38 with bolts 26 extending therefrom, as well as pin 28. Bulkhead mounting bracket 38 is configured to be positioned behind bulkhead 14 with bolts 26 and pins 28 extending through bulkhead pocket 36 and into cargo box 2. Bolts 26 are then attached to wing bulkhead bracket 12 via nuts 40 (see, also, FIG. 5).

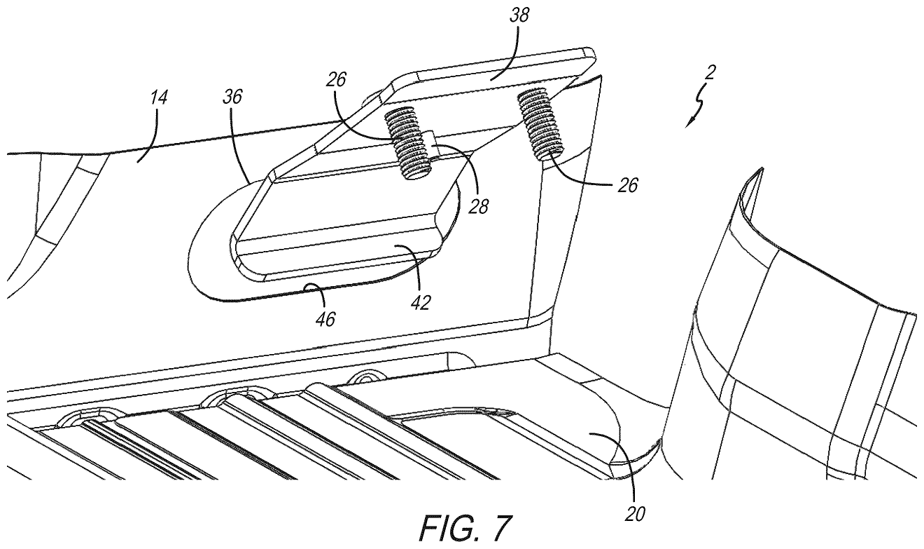

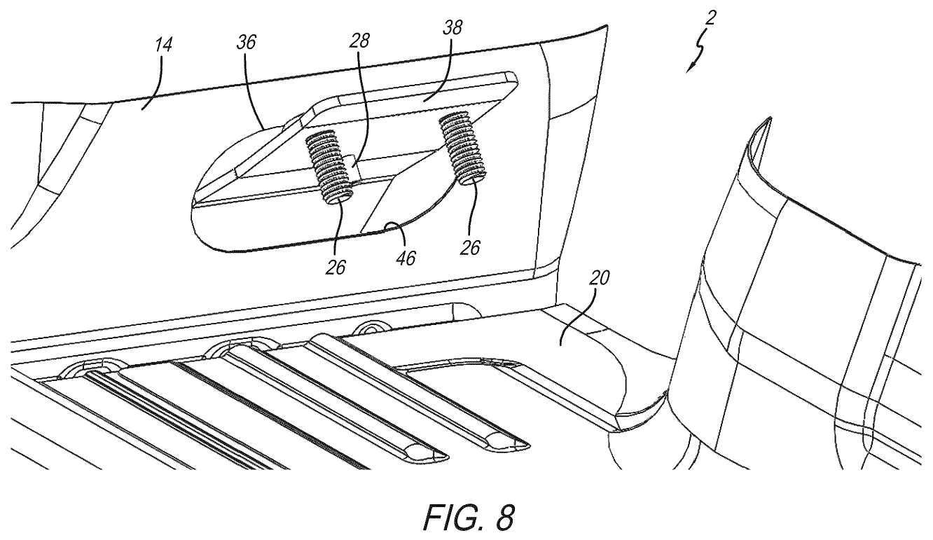

Detail perspective views of a portion of cargo box 2, including bulkhead 14 and floor 20, are further shown in FIGS. 7 and 8. These are progression views that demonstrate how bulkhead mounting bracket 38 is positioned on bulkhead 14. Because, typically, bulkhead 14 is located adjacent the back wall of the cab of the pickup truck (not shown), it may not be possible to access bulkhead pocket 36 via outside of cargo box 2. Therefore, bulkhead mounting bracket 38 is configured, sized, and angled such that it can be extended through bulkhead pocket 36 from inside cargo box 2, as is shown in FIG. 7.

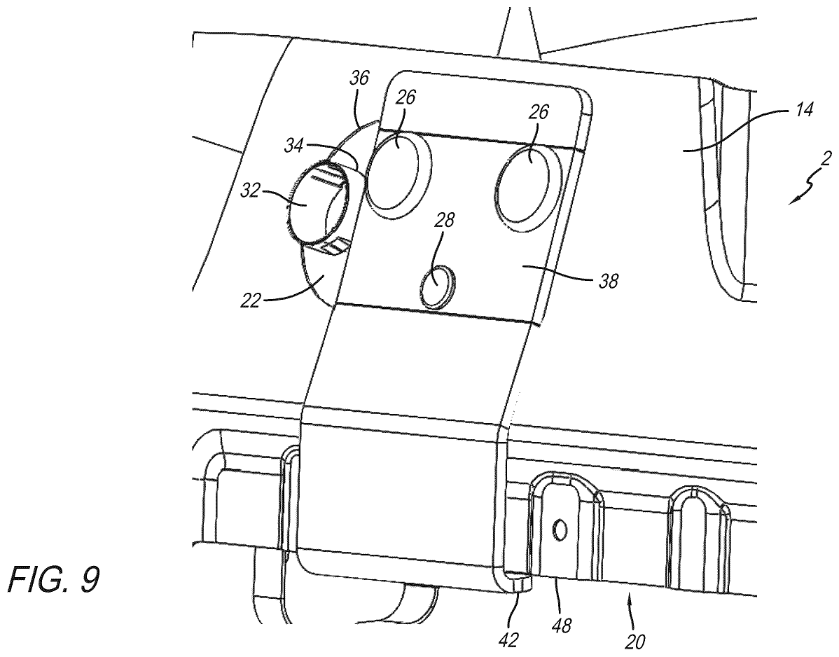

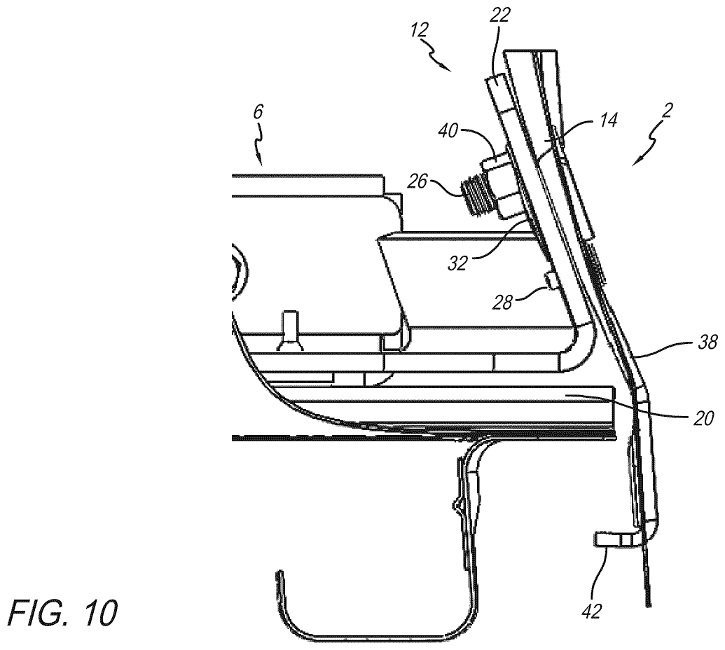

As shown in FIG. 8, bulkhead mounting bracket 38 is disposed further through bulkhead pocket 36 so it can be positioned as that shown in FIG. 6. Pin 28, extending from bulkhead mounting bracket 38, can be used as an arm that rests on bottom periphery or edge 46 of bulkhead pocket 36, as shown in FIG. 6. This helps both with assembly of wing bulkhead bracket 12, as well as positioning bulkhead mounting brackets flange 42 in proper position as further shown herein (see, also, FIGS. 9 and 10). With bolts 26 in position, as determined by pin 28 resting on bottom edge 46 of bulkhead pocket 36, wing bulkhead bracket 12 can be coupled thereto with nuts 40 threaded onto bolts 26.

A reverse detail perspective view of the cargo box 2, opposite floor 20, is shown in FIG. 9. This view depicts bulkhead mounting bracket 38 positioned on this exterior side of bulkhead 14 with flange 42 of bulkhead mounting bracket 38 positioned under floor 20 of cargo box 2. This is to assist in supporting the weight of bedslide assembly 4, particularly when its bedslide deck 18 is located in an extended position from tailgate end 10 of cargo box 2. Under circumstances where weight is being supported by bedslide deck 18, which is extended from tailgate end 10 of cargo box 2, the applied downward force creates an upward force on bedslide frame 6 and, ultimately, wing bulkhead brackets 12 at bulkhead end 8 of cargo box 2. Flange 42 assists in counteracting this upward force being exerted by bedslide assembly 4. As the upward force is being applied, flange 42 hooks onto the bottom front corner 48 of cargo box 2 to resist that and prevent bulkhead mounting bracket 38 and, ultimately, wing bulkhead bracket 12 from moving upward. Also shown in this view are the illustrative head ends of bolts 26 and pin 28 on bulkhead mounting bracket 38.

A side sectional detail view of a portion of cargo box 2, including the floor 20 and bulkhead 14, is shown in FIG. 10. This view further demonstrates how flange 42 of bulkhead mounting bracket 38 helps resist any upward force exerted on wing bulkhead bracket 12 by using cargo box 2 itself. The metal sheets used to form floor 20 and bulkhead 14 of the cargo box 2 come together to create a strong floor structure, a portion of which flange 42 may hook under. Again, this helps resist any upward force exerted on to bulkhead mounting bracket 38 by bedslide assembly 4.

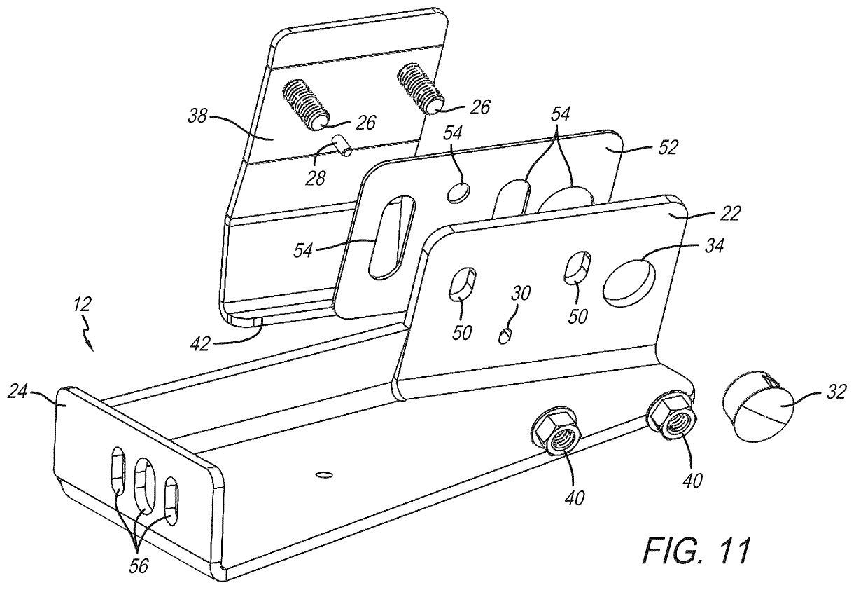

An exploded view of wing bulkhead bracket 12 is shown in FIG. 11. This view depicts the various components of wing bulkhead bracket 12, including bulkhead panel portion 22, bedslide frame portion 24, bolt holes 50, and pin opening 30, as well as drain hole 34. A gasket 52 is located behind bulkhead panel portion 22 and has corresponding openings 54 so that bolts 26 and pin 28 of bulkhead mounting bracket 38 can extend therethrough and through bolt holes 50 and pin opening 30, respectively, of bulkhead panel portion 22. Gasket 52 helps create a seal between bulkhead panel portion 22 of wing bulkhead bracket 12 and bulkhead 14. Mounting holes 56 are also disposed through bedslide frame portion 24 to attach to appropriate locations on bedslide frame 6. If drain hole 34 is not being used, drain hole plug 32 can be fitted therein to seal off that opening.

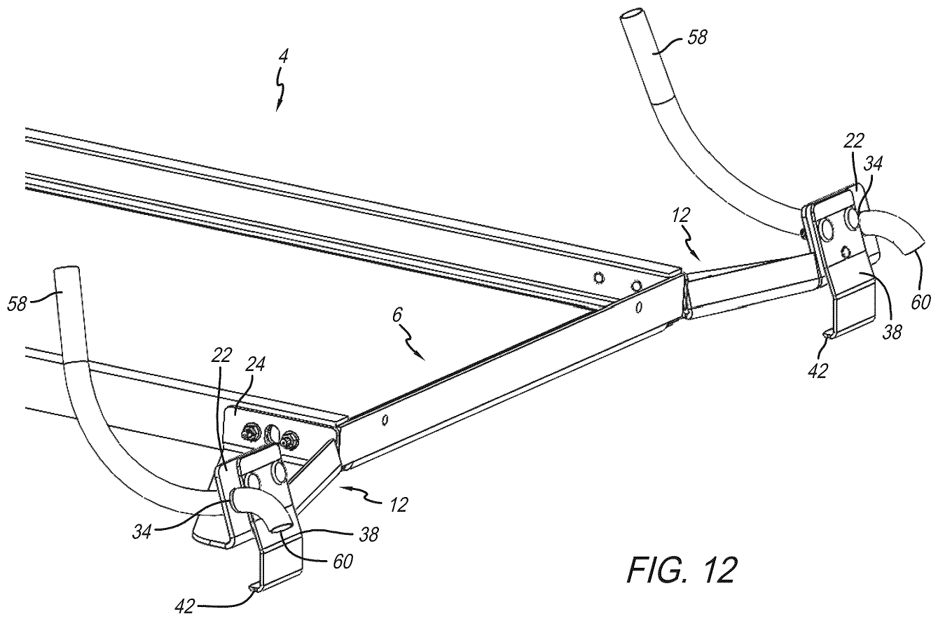

The use of certain cargo box tonneau covers may employ water management that requires drain tubes to extend from rails or rollup cover canisters to direct water out of cargo box 2. Typically, these tubes extend through the cargo box to its exterior. To that end, a reverse perspective detail view of a portion of bedslide frame 6, with wing bulkhead brackets 12 extended from each side, are shown in FIG. 12. A drain tube 58 is depicted extending through drain hole 34 of each bulkhead panel portion 22 of wing bulkhead bracket 12 so drain tube opening 60 extends from the other side. Bulkhead mounting bracket 38 is shown attached to bulkhead panel portion 22 and is sized and configured to not interfere with drain hole 34. When drain tube 58 is installed as shown, drain tube opening 60 will be located on the outside of cargo box 2 so any water that collects in drain tube 58 can be directed to drain tube opening 60 and deposited exterior of cargo box 2. The same configuration is shown on the opposite side of bedslide frame 6 to direct water through drain tube 58 on that side of cargo box 2 to the exterior of same.

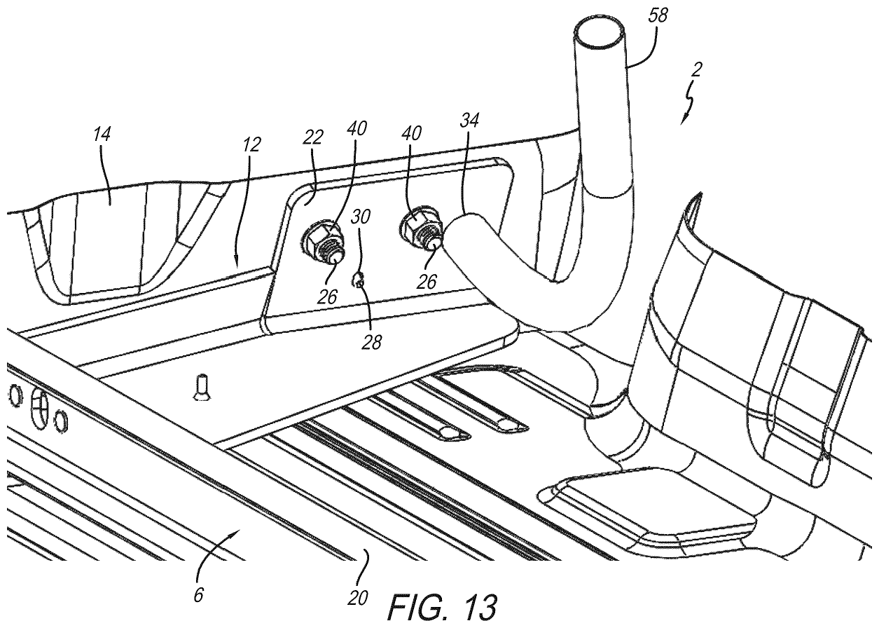

A detail perspective view of a portion of the inside of cargo box 2 is shown in FIG. 13. Here, wing bulkhead bracket 12 is attached to bedslide frame 6 and bulkhead panel 14. Drain tube 58 extends through drain hole 34 in bulkhead panel portion 22. Accordingly, any water that is collected by the drain tube is deposited outside of the cargo box.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features. It should also be appreciated that, to the extent any subject matter disclosed in this non-provisional patent document conflicts with the priority application, the disclosure from this non-provisional patent document controls.

What is claimed:

1. A bedslide mounting bracket assembly configured to secure a bedslide assembly to a pickup truck cargo box, the bedslide mounting bracket assembly comprising:
a wing bulkhead bracket configured to be attached to the bedslide assembly and be located interior of the pickup truck cargo box adjacent a bulkhead;
a bulkhead mounting bracket configured to be positioned exterior of the pickup truck cargo box adjacent the bulkhead;
wherein the bulkhead mounting bracket includes at least one fastener and at least one pin;
wherein the at least one fastener and the at least one pin are oriented substantially parallel to and spaced apart from each other;
wherein the at least one fastener is configured to extend through an opening in the bulkhead from the exterior to the interior of the pickup truck cargo box;
wherein the at least one pin is configured to engage at least a portion of a periphery of the opening in the bulkhead;
wherein the bulkhead mounting bracket includes a drain hole disposed therethrough and wherein the drain hole is configured to receive a drain tube;
wherein the bulkhead mounting bracket includes a flange, at least a portion of which is configured to be positioned under a floor on the exterior of the pickup truck cargo box; and
at least one gasket configured to be positioned between the wing bulkhead bracket and the bulkhead;
wherein the wing bulkhead bracket receives the at least one fastener and the at least one pin of the bulkhead mounting bracket; and
wherein a corresponding nut is engageable with the at least one fastener to secure the wing bulkhead bracket to the bulkhead mounting bracket.

2. The bedslide mounting bracket assembly of claim 1, wherein the wing bulkhead bracket includes a bulkhead panel portion and a bedslide frame portion, wherein the bulkhead panel portion is configured to receive the at least one fastener and the at least one pin of the bulkhead mounting bracket, and the bedslide frame portion is configured to attach to a bedslide frame.

3. The bedslide mounting bracket assembly of claim 1, further comprising a drain hole plug that selectively caps the drain hole.

4. The bedslide mounting bracket assembly of claim 1, wherein the at least one fastener is at least one bolt.

5. The bedslide mounting bracket assembly of claim 1, wherein the at least one pin is configured to be supported by the portion of the periphery of the opening in the bulkhead.

6. The bedslide mounting bracket assembly of claim 1, wherein the bulkhead mounting bracket does not block the drain hole.

7. The bedslide mounting bracket assembly of claim 1, wherein the at least one fastener is a plurality of fasteners, wherein each of the plurality of fasteners extends from the bulkhead mounting bracket and through the wing bulkhead bracket.

8. The bedslide mounting bracket assembly of claim 7, wherein the each of the plurality of fasteners receives the corresponding nut to secure the bulkhead mounting bracket to the wing bulkhead bracket.

9. The bedslide mounting bracket assembly of claim 1, wherein the flange, at least the portion of which is configured to be positioned under the floor on the exterior of the pickup truck cargo box, is configured to resist an upward force exerted on the wing bulkhead bracket by the bedslide assembly.

10. A bedslide mounting bracket assembly configured to secure a bedslide assembly to a pickup truck cargo box, the bedslide mounting bracket assembly comprising:
a wing bulkhead bracket configured to be attached to the bedslide assembly; and
a bulkhead mounting bracket;
wherein the bulkhead mounting bracket includes at least one fastener and at least one pin;
wherein the wing bulkhead bracket receives the at least one fastener and the at least one pin of the bulkhead mounting bracket; and
wherein a corresponding nut is engageable to the at least one fastener to secure the wing bulkhead bracket to the bulkhead mounting bracket.

11. The bedslide mounting bracket assembly of claim 10, wherein the wing bulkhead bracket is configured to be attached to the bedslide assembly and be located interior of the pickup truck cargo box adjacent a bulkhead.

12. The bedslide mounting bracket assembly of claim 10, wherein the bulkhead mounting bracket is configured to be positioned exterior of the pickup truck cargo box adjacent a bulkhead.

13. The bedslide mounting bracket assembly of claim 10, wherein the at least one fastener and the at least one pin are oriented substantially parallel to and spaced apart from each other.

14. The bedslide mounting bracket assembly of claim 12, wherein the at least one fastener is configured to extend through an opening in the bulkhead from the exterior to an interior of the pickup truck cargo box.

15. The bedslide mounting bracket assembly of claim 10, wherein the at least one pin is configured to engage at least a portion of a periphery of an opening in a bulkhead.

16. The bedslide mounting bracket assembly of claim 10, further comprising a drain hole disposed through the bulkhead mounting bracket and configured to receive a drain tube.

17. The bedslide mounting bracket assembly of claim 10, wherein the bulkhead mounting bracket further comprises a flange, wherein at least a portion of which is configured to be positioned under a floor on an exterior of the pickup truck cargo box.

18. The bedslide mounting bracket assembly of claim 10, further comprising at least one gasket configured to be positioned between the wing bulkhead bracket and a bulkhead.

19. A method of mounting a bedslide bracket assembly to a bedslide assembly and a bulkhead of a pickup truck cargo box method of mounting a bedslide bracket assembly comprising the steps of:
providing a wing bulkhead bracket;
attaching the wing bulkhead bracket to a bedslide frame of the bedslide assembly;
providing a bulkhead mounting bracket having at least one fastener, at least one pin, and a flange;
extending the bulkhead mounting bracket through an opening disposed through the bulkhead to an exterior of the pickup truck cargo box;
locating at least a portion of the flange of the bulkhead mounting bracket under a floor of the pickup truck cargo box;
extending the at least one fastener and the at least one pin through the opening disposed through the bulkhead to the interior of the pickup truck cargo box;
supporting the at least one pin on a periphery of the opening disposed through the bulkhead of the pickup truck cargo box;
extending the at least one fastener and the at least one pin through corresponding openings in the wing bulkhead bracket that is in the interior of the pickup truck cargo box; and
securing the at least one fastener to the wing bulkhead bracket.

20. The method of mounting the bedslide bracket assembly of claim 19, further comprising the steps of: extending the bulkhead mounting bracket through the opening disposed through the bulkhead from the interior of the pickup truck cargo box to exterior of the pickup truck cargo box.
